(19) United States
(12) Patent Application Publication
(10) Pub. No.: US 2026/0079316 A1
(43) Pub. Date: Mar. 19, 2026

(54) Splice Holder with Fiber Optic Connectors

(71) Applicant: NSI-Lynn Electronics, LLC, Huntersville, NC (US)

(72) Inventor: Charles Hoskins, Miamisburg, OH (US)

(73) Assignee: NSI-Lynn Electronics, LLC, Huntersville, NC (US)

(21) Appl. No.: 19/330,710

(22) Filed: Sep. 16, 2025

Related U.S. Application Data
(60) Provisional application No. 63/695,544, filed on Sep. 17, 2024.

(51) Int. Cl. G02B 6/44

(52) U.S. Cl. CPC G02B 6/4454

(57) ABSTRACT

A splice tray and methods of use are disclosed. The splice tray having fiber optic connectors attached to built-in holders. The splice tray includes a volume for holding fibers of a fiber optic cable. Fibers are fed into the splice tray through entry gaps, and are coiled within the splice tray. Spliced segments of fiber are held in a splice holder. Fibers are spliced to the fiber optic connectors. The splice tray ensures protection of fibers within, and minimizes the need to access the components within.

### CROSS-REFERENCE TO RELATED APPLICATIONS

This application claims the benefit of priority under 35 U.S.C. § 119(e) to U.S. Provisional Patent Application Ser. No. 63/695,544 filed on Sep. 17, 2024, entitled Splice Holder with Fiber Optic Connectors, the entire contents of which is hereby incorporated by reference.

### BACKGROUND

### 1. Field of the Disclosure

The present disclosure is directed to splice trays for optical fiber management and methods of using the same, and more particularly to splice trays which include holders for commonly used fiber optic connectors/adapters and a method of securing the holders to the frame of the splice tray.

### 2. Background of the Related Art

In the field of fiber optics, fiber management is often accomplished through the use of a splice holders or trays. Such an apparatus commonly includes a volume for storing coils of fibers, and channel sections for holding the spliced segments of said fibers. The splice tray apparatus further includes an entry opening and an exit opening.

Current splice tray designs include several deficiencies which complicate their use. Presently, current splice trays do not incorporate modern industry-standard connectors. As a result, cost and complexity of fiber optic installations is increased due to needing an external connector and requisite holder, thus increasing part count and installation size. An external connector arrangement also necessitates that the pigtails of the fiber optic cable must be exposed when exiting the tray to connect with an external connector, which increases the risk of damage to the fibers. Installation and maintenance are also complicated, as an external connector holder requires technicians to access the more sensitive components within the splice tray over the course of the project.

Accordingly, a new splice tray design is needed which cures these deficiencies by including holders for commonly used fiber optic connectors and a method of securing the holders to the frame of the splice tray.

This section is intended to introduce the reader to various aspects of art that may be related to various features of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

According to some embodiments of the present disclosure, a splice tray is provided. The splice tray has a base, side walls, an entry wall, an exit wall, and a top. The base, side walls, entry wall, exit wall, and top define a volume within which fibers of a fiber optic cable may be stored. The entry wall and side walls define entry gaps or passages. The exit wall and side walls include at least one mechanism, such as a holder for fiber optic connectors. Fiber optic connectors such as, but not limited to, SC adapters can be used without departing from the scope of the present disclosure. The base has means to attach a splice holder which can securely hold fiber splices. The base further has means to coil fibers in a secure manner.

The slice tray according to the present disclosure protects optical fibers stored within from harmful environmental effects. The splice tray additionally reduces the number of parts required in a fiber optic installation by directly including the fiber optic connectors. Furthermore, the incorporation of fiber optic connectors reduces the need to access the sensitive fibers stored within the splice tray which connecting to the pigtail fibers.

### BRIEF DESCRIPTION OF DRAWINGS

The subject matter, which is regarded as the disclosure, is particularly pointed out in the specification. The foregoing and other features, and advantages of the disclosure are apparent from the following detailed description taken in conjunction with the accompanying drawings in which like reference numerals refer to like elements throughout the different views:

FIG. 1 is a perspective view of a splice tray according to an embodiment of the present disclosure with the top cover shown disengaged from the body of the tray;

FIG. 2 is a top view of the splice tray embodiment shown in FIG. 1 shown with the cover removed;

FIG. 3 is a side view of the splice tray embodiment shown in FIG. 1;

FIG. 4 is a bottom view of the splice tray embodiment shown in FIG. 1;

FIG. 5 is an end view of the splice tray embodiment shown in FIG. 1;

FIG. 6A is a perspective view of an exemplary embodiment of a splice holder module; and

FIG. 6B is a perspective view of an additional exemplary embodiment of a splice holder module.

### DETAILED DESCRIPTION

In the following specification and the claims, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

The subject matter disclosed herein relates to a splice tray for housing connections between fiber optic cables. More specifically, the present disclosure relates to a splice tray with an integrated fiber optic connector for fiber optic cables.

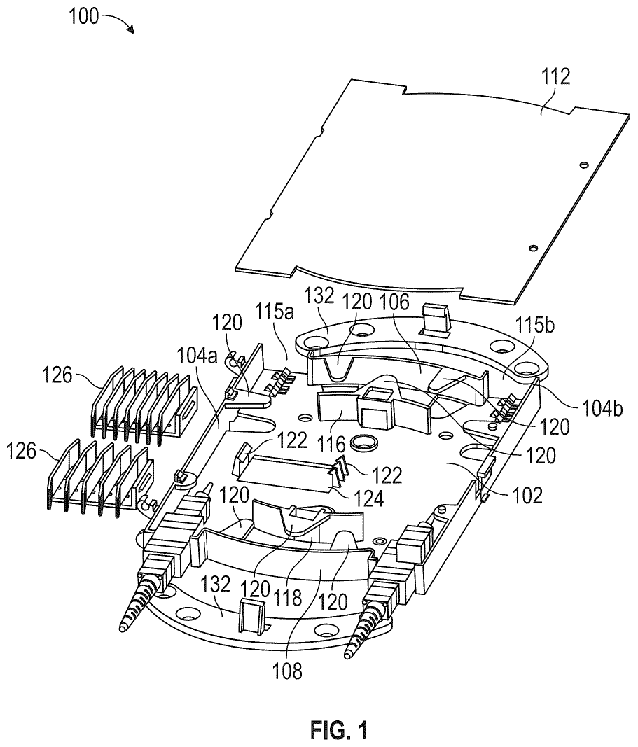

Referring now to FIG. 1, shown is a splice tray 100 according to the embodiments of the present disclosure. According to some embodiments, the splice tray 100 may include a base 102, side walls 104a-b, an entry wall 106, and an exit wall 108. The base 102 is characterized by a flat sheet with a substantially rectangular or oval-like shape, with two longer sides corresponding to the side walls 104a and 104b, and the short sides corresponding to the entry wall 106 and the exit wall 108. In the embodiment shown, the entry wall 106 and the exit wall 108 do not extend the complete distance between the side walls 104a and 104b on their respective sides. The base 102, cover 112, side walls 104a-b, entry wall 106, and exit wall 108 define a volume.

The splice tray 100 is designed such that fiber optic cables and the fibers or pigtails thereof (not shown), can be effectively stored in a manner which protects the fibers from damage. Fibers are fed into the splice tray through entry gaps 115a and 115b, which are defined by the gap created between the entry wall 106 and side walls 104a-b. The base 102 is equipped with a first retainer wall 116 and a second retainer wall 118. The first retainer wall 116 is positioned near the entry wall 106 such as to form a channel within which fibers can be placed. Furthermore, the first retainer wall 116 is arched such that fibers are broadly directed towards the exit wall 108. The second retainer wall 118 is positioned opposite the first retainer wall 116, and similarly forms a channel with the exit wall 108. The second retainer wall 118 is arched in the opposite direction as the first retainer wall 116. The first retainer wall 116, the second retainer wall 118, the side walls 104a-b, the entry wall 106, and the exit wall 108 are all equipped with a plurality of tabs 120, which extend over the path of the fibers and ensure that the fibers cannot escape the channels.

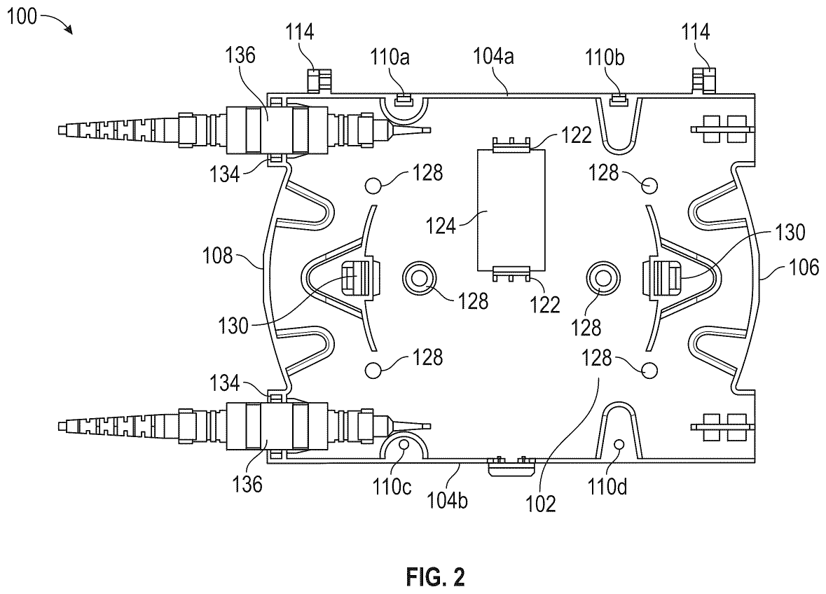

According to an embodiment shown in FIG. 2, the side walls 104a and 104b can include a plurality of attachment points 110a-d, to which a top 112 (shown in FIG. 1) can be attached. Attachment points 110a-d can be hinges, hooks, clips, screws, or other methods of attaching two components known in the art, or any combination or selection thereof. According to an embodiment shown in FIGS. 1 and 2, attachment points 110a-b are hooks, and attachment points 110c-d are holes through which a screw can be threaded. In some embodiments, the side walls 104a and 104b may also include expansion hooks 114, which may be used to attach adjacent splice trays to each other (see in particular side wall 104a in FIG. 2).

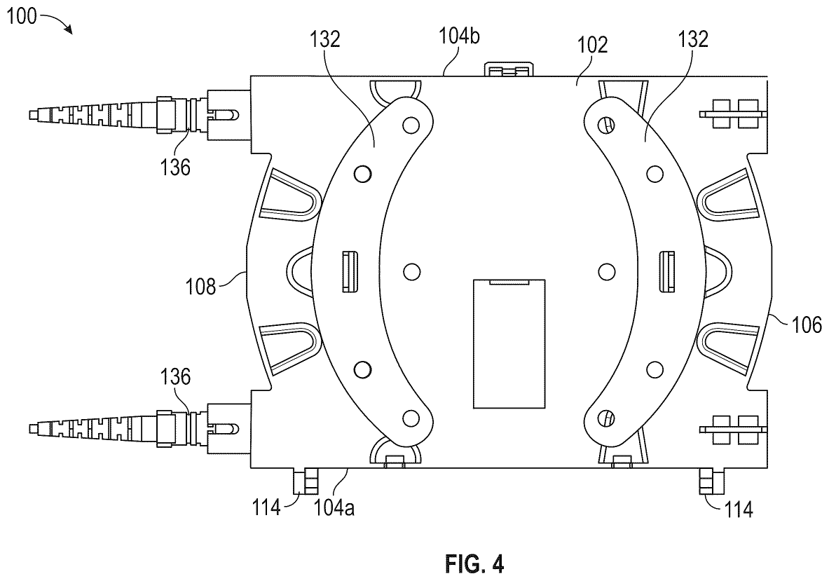

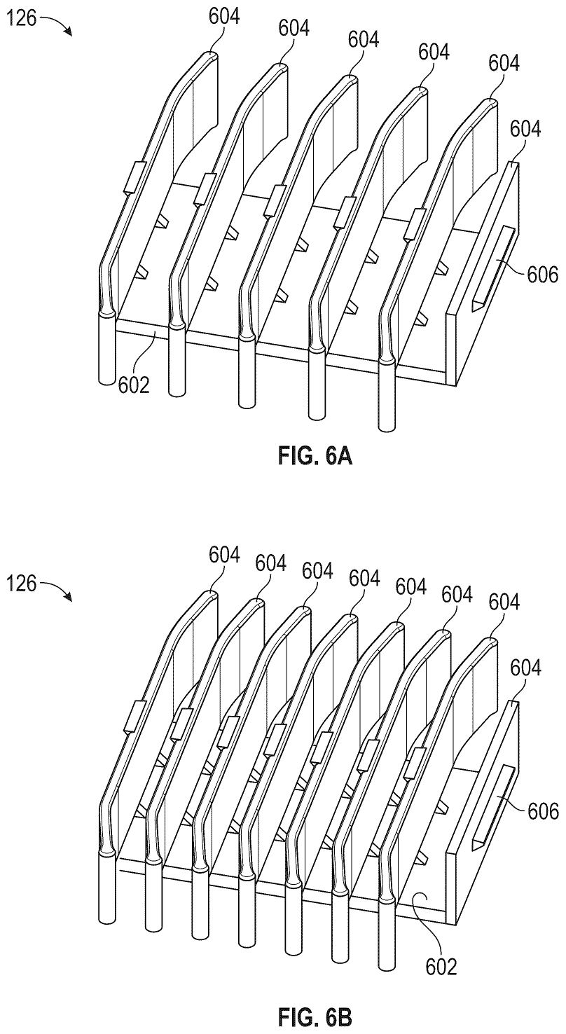

The base 102 includes at least two holder clips 122 positioned about a gap 124. The holder clips 122 and the gap 124 are designed such that a splice holder 126 (two embodiments shown in FIG. 1 and FIG. 6A/6B) can be placed in the gap 124 and securely held in place by the clips 122 by way of a snap-fit mechanism. The splice holder 126 will be described in greater detail in relation to FIG. 6, but is generally included in the path that fibers take through the splice tray 100. The base 102 additionally includes a plurality of mounting holes 128 which can be used to mount the splice tray 100 to a surface in the environment. In some embodiments, the first retainer wall 116 and the second retainer wall 118 are similarly equipped with mounting attachment points 130. Mounting trays 132 (see FIG. 1) can optionally be connected to the mounting attachment points 130 to provide additional mounting options (see FIG. 4).

The exit wall 108 and the side walls 104a-b define the edges of two holders 134 into which fiber optic connectors/couplers/adapters 136 can be inserted. As best shown in FIG. 2, in some embodiments the holders 134 include a series of channels into which a flange on a standardized fiber optic connector 136 snugly fits. The fiber optic connectors/couplers/adapters 136 may be characterized by any fiber optic connector type known in the art, such as for example, SC, ST, LC, MTRJ and MTP type connectors. Those skilled in the art will readily appreciate that other techniques can be used for removably securing the fiber optic connectors 136 to the tray without departing from the scope of the present invention.

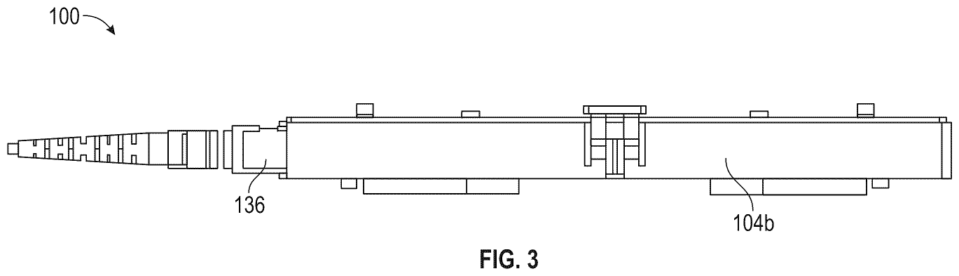

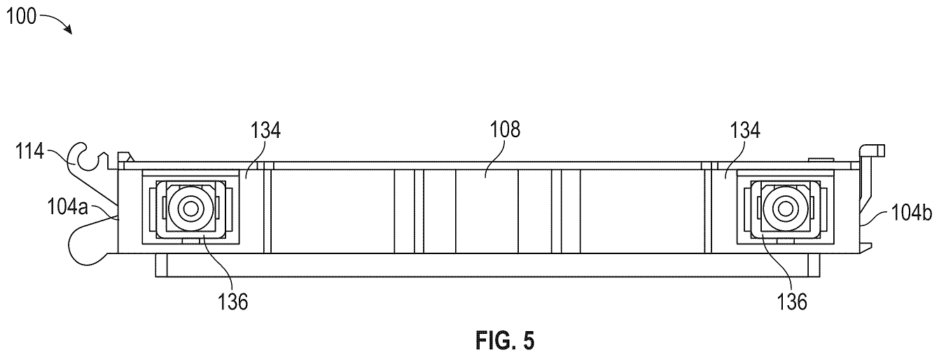

FIGS. 3 and 5 respectively show a side and front view of the splice tray.

Referring now to FIGS. 6a and 6b, the splice holder 126 includes a floor 602 and a plurality of walls 604. In combination, the floor 602 and the plurality of walls 604 form a series of channels, into which spliced sections of fiber can be snugly inserted. The channels ensure that the spliced sections are protected. The splice holder 126 also includes one or more clip points 606, which interface with the holder clips 122 of the base 102. In some embodiments, the clip points 606 are positioned on the outermost wall 604. Depending on the application, the splice holder 126 may be configured in a variety of ways. FIG. 6a shows an example embodiment characterized by a total of five channels, and FIG. 6b shows an example embodiment of the splice holder 126 characterized by a total of seven channels.

According to an embodiment, a method of operation of the splice tray 100 includes feeding fiber optic cables into the splice tray using one or both entry gaps 115a-b. Excess fiber optic cable fibers (not shown) are coiled within the splice tray utilizing the channels created by the entry wall 106, the exit wall 108, the first retainer wall 116, and the second retainer wall 118. The plurality of tabs 120 ensure that the fibers cannot “jump” out of the channels. Coils largely follow an oval or figure eight-like path about the splice tray 100. Spliced sections of each fiber are inserted into the channels of splice holder 126. The ends of the fibers are spliced to the fiber optic connectors 136 which are then secured to the tray. The top 112 of the splice tray 100 is attached to protect the fibers within and prevent the connectors from dislodging. With the top 112 attached, the splice tray 100 is sufficiently enclosed as to minimize the intrusion of harmful particles, UV radiation, and other detrimental environmental factors. Furthermore, the inclusion of fiber optic connectors 136 in the system minimizes the need to access the splice tray 100 for routine maintenance or installations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A splice tray comprising:
a planar base;
opposing first and second side walls projecting upward from opposing lateral edges of the base;
an entry wall projecting upward from a first end of the base; the entry wall being arranged and configured to define first and second entry passages for fiber optic cables;
an exit wall projecting upward from a second end of the base, the exit wall being arranged and configured to define first and second entry passages for the fiber optic cables;
a top;
wherein the base, first and second side walls and top form an internal cavity for fiber optic cables; and wherein the exit wall and first side wall each include portions of a first holder mechanism for releasably securing a first fiber optic coupler thereto and the exit wall and second side wall each include portions of a second holder mechanism for releasably securing a second fiber optic coupler thereto.

2. The splice tray as recited in claim 1, wherein the first and second fiber optic couplers are SC adapters.

3. The splice tray as recited in claim 1, further comprising one or more splice holders for securing spliced regions on the fiber optic cables within the internal cavity of the splice tray.

4. The splice tray as recited in claim 3, wherein the base includes one or more mechanism for releasably securing the one or more splice holders within the internal cavity of the splice tray.

5. The splice tray as recited in claim 1, wherein the first holder mechanism includes opposing channels for slidably receiving a flange formed on the first fiber optic coupler.

6. The splice tray as recited in claim 1, wherein the first and second holder mechanisms are dimensioned and configured to allow different types of fiber optic couplers to be releasably secured therein.

7. The splice tray as recited in claim 1, further comprising means associated with the base for allowing the splice tray to be mounted to a fixed structure.

8. The splice tray as recited in claim 1, further comprising means associated with either the first or the second side wall for allowing the splice tray to be connected to a second splice tray.

9. The splice tray as recited in claim 1, wherein the base, first and second side walls, entry wall and exit wall are formed as a unitary structure.
